(19) United States
(12) Patent Application Publication
(10) Pub. No.: US 2017/0236350 A1
(43) Pub. Date: Aug. 17, 2017

(54) ELECTRONIC DOOR LOCK SYSTEM

(71) Applicant: Linctronix Ltd., New Taipei City (TW)

(72) Inventor: Yu-Shun Lin, NEW TAIPEI CITY (TW)

(21) Appl. No.: 15/428,143

(22) Filed: Feb. 8, 2017

(30) Foreign Application Priority Data
Feb. 16, 2016 (TW) 105104434

(51) Int. Cl. G07C 9/00; H04H 20/16; H04W 76/02; H04W 4/00

(52) U.S. Cl. CPC G07C 9/00309; H04W 4/008; H04H 20/16; H04W 76/023; G07C 2009/00412; H04W 84/12

(57) ABSTRACT

An electronic door lock system is provided. It comprises a portable electronic device and an electronic door lock device. The portable electronic device comprises a first Bluetooth communication module. The electronic door lock device comprises a second Bluetooth communication module communicated to the portable electronic device via a Bluetooth wireless connection. When the portable electronic device is Bluetooth paired to the electronic door lock device, an authorization code is exchanged between the first Bluetooth communication module and the second Bluetooth communication module. When the portable electronic device is near to the electronic door lock device, the authorization code is matched between the portable electronic device and the electronic door lock device. After the match is confirmed, the electronic door lock device will be unlocked. Compared to the prior art, the present invention offers users more convenient using experience.

### BACKGROUND OF THE INVENTION

1. Field of the Invention

The present invention relates to an electronic door lock system, more particularly, to an electronic door lock system by utilizing a Bluetooth communication method for the portable electronic device as an electronic door lock key.

2. Description of the Prior Art

The present Bluetooth public door lock systems are set by cipher settings, keys, RF proximity cards or bracelets as static door locks which cannot be set dynamically. This phenomenon may be improved by some Bluetooth door locks but limited to one door lock for private home use only and mostly set by utilizing smart mobile devices. However, regarding the door locks for the public fields, it is still lack of a mechanism of central control or a time sharing system for many people to use simultaneously or non-simultaneously. Therefore, the aforementioned prior art has so many disadvantages, and it needs to be improved further.

### SUMMARY OF THE INVENTION

In order to solve the aforementioned problem, an electronic door lock system of the present invention is provided. By utilizing a Bluetooth communication module of a portable electronic device which is Bluetooth paired to another Bluetooth communication module of an electronic door lock device for exchanging an authorization code to establish a Bluetooth paired connection, a user can utilize the above-mentioned authorization code as an electronic key to unlock the electronic door lock via the portable electronic device.

A category of the present invention provides an electronic door lock system, which comprises a portable electronic device and an electronic door lock device. The portable electronic device comprises a first Bluetooth communication module and the electronic door lock device comprises a second Bluetooth communication module, wherein the portable electronic device is connected to the electronic door lock device via a Bluetooth wireless communication.

When the portable electronic device is Bluetooth paired to the electronic door lock device, an authorization code is exchanged between the first Bluetooth communication module and the second Bluetooth communication module. After the Bluetooth paired connection is established, when the portable electronic device is near to the electronic door lock device, the authorization code is matched and verified between the portable electronic device and the electronic door lock device. After the match is confirmed, the electronic door lock device will be unlocked.

In one embodiment of the present invention, the authorization code is transmitted to the electronic door lock device via the portable electronic device.

In one embodiment of the present invention, the authorization code is transmitted to the portable electronic device via the electronic door lock device.

In one embodiment of the present invention, a broadcast message is delivered from the first Bluetooth communication module and the broadcast message is received by the second Bluetooth communication module to establish the Bluetooth paired connection.

Another category of the present invention provides an electronic door lock system, which comprises a portable electronic device, a console and an electronic door lock device. The portable electronic device comprises a first Bluetooth communication module. The console comprises a third Bluetooth communication module, which is connected to the portable electronic device via a Bluetooth communication. And the electronic door lock device is electrically connected with the console.

When the portable electronic device is Bluetooth paired to the console, an authorization code is exchanged between the first Bluetooth communication module and the third Bluetooth communication module. After the Bluetooth paired connection is established, when the portable electronic device is near to the console, the authorization code is matched and verified between the portable electronic device and the console. After the match is confirmed, a control signal is delivered from the console to the electronic door lock device so as to unlock the electronic door lock device.

In one embodiment of the present invention, the authorization code can be a media access control (MAC) address of the first Bluetooth communication module, a media access control (MAC) address of the third Bluetooth communication module or a crypto code.

Compared to the prior art, the past one-to-one electronic door lock devices are promoted to many-to-one electronic door lock devices by utilizing the present invention, which can be applied for the public lockers or the access control systems to offer users more convenient using experience.

### BRIEF DESCRIPTION OF THE APPENDED DRAWINGS

FIG. 1 is a functional block diagram according to one embodiment of the present invention.

FIG. 2 is a functional block diagram according to another embodiment of the present invention.

FIG. 3 is a functional block diagram according to the other embodiment of the present invention.

### DETAILED DESCRIPTION OF THE INVENTION

In order to allow the advantages, spirit and features of the present invention to be more easily and clearly understood, the embodiments and appended drawings thereof are discussed in the following. However, the present invention is not limited to the embodiments and appended drawings.

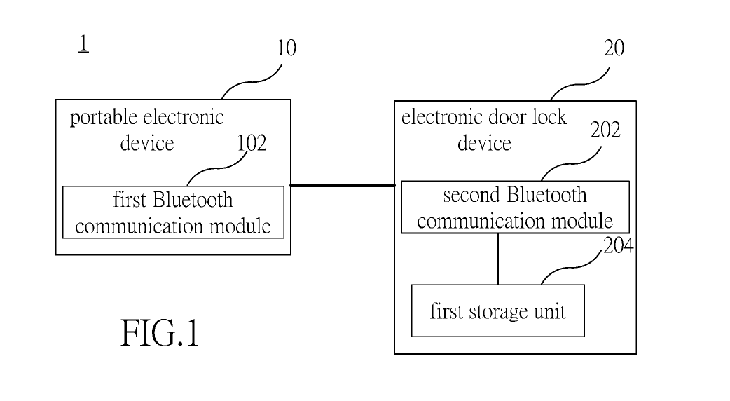

Please refer to FIG. 1, which is a functional block diagram according to one embodiment of the present invention. The present invention provides an electronic door lock system 1, which comprises a portable electronic device 10 and an electronic door lock device 20. The portable electronic device 10 comprises a first Bluetooth communication module 102. The electronic door lock device 20 comprises a second Bluetooth communication module 202 and a first storage unit 204. The portable electronic device 10 is connected to the electronic door lock device 20 via a Bluetooth wireless communication. After a Bluetooth paired connection is established between the portable electronic device 10 and the electronic door lock device 20, a door installed with the electronic door lock device 20 can be unlocked by utilizing the portable electronic device 10 for an user.

The portable electronic device 10 can be a smart mobile device, such as a mobile phone, a tablet computer or a watch or bracelet of the smart wearable devices. The Bluetooth wireless communication comprises any versions of Bluetooth communication protocol defined by Bluetooth Special Interest Group (SIG), such as Bluetooth 2.0 communication protocol series, Bluetooth 3.0 communication protocol series or Bluetooth 4.0 communication protocol series.

An application program can be executed on the portable electronic device 10 to establish the Bluetooth paired connection, and a Bluetooth paired relationship between the portable electronic device 10 and the door lock device 20 is established by utilizing the application program. A broadcast message is delivered from the first Bluetooth communication module 102 and the broadcast message is received by the second Bluetooth communication module 202 to establish the Bluetooth paired connection. Additionally, a broadcast message can be delivered from the second Bluetooth communication module 202 and the broadcast message can be received by the first Bluetooth communication module 102 to establish the Bluetooth paired connection. In the embodiment of the present invention, a user can utilize the portable electronic device 10 to approach the door lock device 20 to execute the Bluetooth paired connection.

When the Bluetooth paired connection is established, an authorization code is exchanged between the first Bluetooth communication module 102 and the second Bluetooth communication module 202 as a certification for connection with each other. The authorization code can be transmitted to the electronic door lock device 20 via the portable electronic device 10, and vice versa. The authorization code can be a media access control (MAC) address of the first Bluetooth communication module 102, a media access control (MAC) address of the second Bluetooth communication module 202 or a crypto code. In the present embodiment of the present invention, the authorization code is transmitted to the electronic door lock device 20 via the portable electronic device 10 and stored in the first storage unit 204. However, it is not limited herein, and the authorization code can also be stored in the storage medium of the portable electronic device 10.

After the Bluetooth paired connection is established, when a user gets the portable electronic device 10 to approach the electronic door lock device 20, the authorization code is matched between the portable electronic device 10 and the electronic door lock device 20. After the match is confirmed, the electronic door lock device 20 will be unlocked.

In the embodiment of the present invention, a plurality set of the authorization codes can be stored in the first storage unit 204, so as to unlock the doors installed with the electronic door lock device 20, such as the electronic lock applied in the public lockers, via a plurality of the portable electronic devices 10. Furthermore, when the Bluetooth paired connection is executed, users can set the door lock settings of the portable electronic devices 10 by utilizing the aforementioned application program. The door lock settings mainly comprise an authorization code, a duration selection, a distance selection and a door lock number. The duration selection can be an initial time plus a time interval, an initial time and a terminal time, a daily fixed time period, a weekly fixed time period, a monthly fixed time period or one fixed time period of a specific interval time. The distance selection can be a distance of a Bluetooth Received Signal Strength Indicator (RSSI) emitted from the portable electronic device 10 measured by the electronic door lock device 20 or a distance which is estimated from the Bluetooth Received Signal Strength Indicator (RSSI). The door lock number represents more than one control right set on the door lock corresponding to the electronic door lock device 20.

By utilizing the aforementioned door lock settings, users can set the time period in which the electronic door lock device 20 can be unlocked by the portable electronic device 10 or set a sensing distance between the portable electronic device 10 and the electronic door lock device 20 for unlocking the access control of the electronic door lock device 20 or set the number for allowing the portable electronic device 10 to access the electronic door lock device 20. In the embodiment of the present invention, after the users set the foregoing door lock settings, when the portable electronic device 10 is near to the electronic door lock device 20, all parameters of the door lock settings which comprise the authorization code, the duration selection, the distance selection and the door lock number will be matched by the electronic door lock device 20. After the match of all the parameters is confirmed, the access control of the electronic door lock device 20 will be unlocked by the portable electronic device 10.

Furthermore, a mobile payment mechanism can be set up in the door lock settings to be utilized as a method for charging an admission fee. The users can pay via the electronic wallets, the telecom mobile payment, credit cards or the on-line payment by utilizing the portable electronic device 10 to acquire the qualification of the Bluetooth paired connection established between the portable electronic device 10 and the electronic door lock device 20, and then the Bluetooth paired connection can be established. Additionally, the qualification of the Bluetooth paired connection established between the portable electronic device 10 and the electronic door lock device 20 can be acquired first to build up the Bluetooth paired connection for unlocking the electronic door lock device 20. When the portable electronic device 10 is near to the electronic door lock device 20 for accessing the electronic door lock device 20 next time, the fee is charged afterwards because the authorization code is not matched.

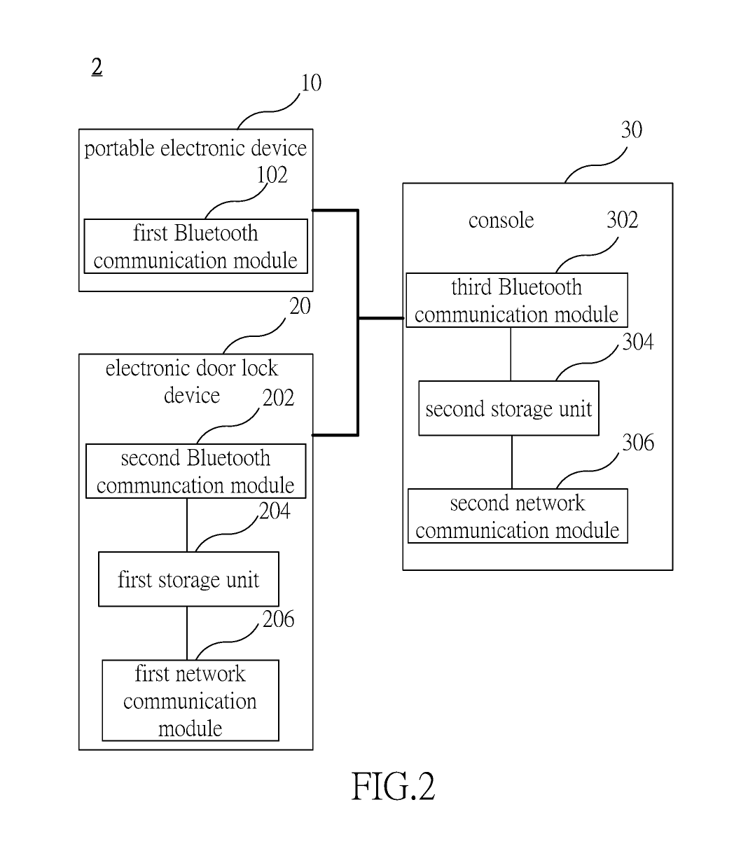

Please refer to FIG. 2, which is a functional block diagram according to another embodiment of the present invention. Another category of the present invention provides an electronic door lock system 2, which comprises a portable electronic device 10, a console 30 and an electronic door lock device 20. The portable electronic device 10 comprises a first Bluetooth communication module 102. The console 30 comprises a third Bluetooth communication module 302 and a second storage unit 304, communicated to the portable electronic device 10 via a Bluetooth wireless communication. And the electronic door lock device 20 is electrically connected with the console 30. After the portable electronic device 10 is Bluetooth paired to the console 30, a user can utilize the portable electronic device 10 to unlock the door installed with the electronic door lock device 20 via the console 30.

The portable electronic device 10 can be a smart mobile device, such as a mobile phone, a tablet computer or a watch or bracelet of the smart wearable devices. The Bluetooth wireless communication comprises any versions of Bluetooth communication protocol defined by Bluetooth Special Interest Group (SIG), such as Bluetooth 2.0 communication protocol series, Bluetooth 3.0 communication protocol series or Bluetooth 4.0 communication protocol series. The console 30 can be a control device which is installed beside the door, such as a sensor of the key fob or an automatic recognition system of the access control system.

An application program can be executed on the portable electronic device 10 to establish the aforementioned Bluetooth paired connection, and a Bluetooth paired relationship between the portable electronic device 10 and the console 30 is established by utilizing the application program. A broadcast message is delivered from the first Bluetooth communication module 102 and the broadcast message is received by the third Bluetooth communication module 302 to establish the Bluetooth paired connection. Additionally, a broadcast message can be delivered from the third Bluetooth communication module 302 and the broadcast message can be received by the first Bluetooth communication module 102 to establish the Bluetooth paired connection. In the embodiment of the present invention, a user can utilize the portable electronic device 10 to approach the door lock device 20 to execute the Bluetooth paired connection.

When the Bluetooth paired connection is established, an authorization code is exchanged between the first Bluetooth communication module 102 and the third Bluetooth communication module 302 to be utilized as a certification for connection with each other. The authorization code can be transmitted to the console 30 via the portable electronic device 10, and vice versa. The authorization code can be a media access control (MAC) address of the first Bluetooth communication module 102, a media access control (MAC) address of the third Bluetooth communication module 302 or a crypto code. In the present embodiment of the present invention, the authorization code is transmitted to the console 30 via the portable electronic device 10 and stored in the second storage unit 304. However, it is not limited herein, and the authorization code can also be stored in the storage medium of the portable electronic device 10 or the first storage unit 204.

After the Bluetooth paired connection is established, when a user gets the portable electronic device 10 to approach the console 30, the authorization code is matched between the portable electronic device 10 and the console 30. After the match is confirmed, a control signal is delivered from the console 30 to the electronic door lock device 20 so as to unlock the electronic door lock device 20. In another embodiment of the present invention, the authorization code stored in the first storage unit 204 can be accessed by the console 30 to be mutual matched and verified by the portable electronic device 10. After the match is confirmed, a control signal is delivered from the console 30 to the electronic door lock device 20 so as to unlock the electronic door lock device 20.

In one embodiment of the present invention, the console 30 can be electrically connected with the electronic door lock device 20 by utilizing the electric wires. But it is not limited herein; a Bluetooth wireless connection can be established between the second Bluetooth communication module 202 of the electronic door lock device 20 and the third Bluetooth communication module 302 of the console 30. In addition, the electronic door lock device 20 further comprises a first network communication module 206 and the console 30 further comprises a second network communication module 306. A communication between the first network communication module 206 and the second network communication module 306 is utilized for connecting the console 30 and the electronic door lock device 20. The first network communication module 206 and the second network communication module 306 are communicated by utilizing an Ethernet local area network module, a Wi-Fi wireless local area network module, other cable network modules or other wireless network modules for communication.

In one embodiment of the present invention, a plurality set of the authorization codes can be stored in the second storage unit 304, so as to unlock the doors installed with the console 30 and the electronic door lock device 20, such as the electronic lock applied in the public lockers, via a plurality of the portable electronic devices 10. Furthermore, when the Bluetooth paired connection is executed, users can set the door lock settings of the portable electronic devices 10 by utilizing the aforementioned application program. The door lock settings mainly comprise an authorization code, a duration selection, a distance selection and a door lock number. The duration selection can be an initial time plus a time interval, an initial time and a terminal time, a daily fixed time period, a weekly fixed time period, a monthly fixed time period or one fixed time period of a specific interval time. The distance selection can be a distance of a Bluetooth Received Signal Strength Indicator (RSSI) emitted from the portable electronic device 10 measured by the console 30 or a distance which is estimated from the Bluetooth Received Signal Strength Indicator (RSSI). The door lock number represents more than one control right set on the door lock corresponding to the electronic door lock device 20.

By utilizing the aforementioned door lock settings, users can set the time period in which the electronic door lock device 20 can be unlocked by the portable electronic device 10 or set a sensing distance between the portable electronic device 10 and the console 30 for unlocking the access control of the electronic door lock device 20 or set the number for allowing the portable electronic device 10 to access the electronic door lock device 20. In the embodiment of the present invention, after the users set the foregoing door lock settings, when the portable electronic device 10 is near to the console 30, all parameters of the door lock settings which comprise the authorization code, the duration selection, the distance selection and the door lock number will be matched by the electronic door lock device 20. After the match of all the parameters is confirmed, the access control of the electronic door lock device 20 will be unlocked by the portable electronic device 10.

Furthermore, a mobile payment mechanism can be set up in the door lock settings to be utilized as a method for charging an admission fee. The users can pay via the electronic wallets, the telecom mobile payment, credit cards or the on-line payment by utilizing the portable electronic device 10 to acquire the qualification of the Bluetooth paired connection established between the portable electronic device 10 and the console 30, and then the Bluetooth paired connection can be established. Additionally, the qualification of the Bluetooth paired connection established between the portable electronic device 10 and the console 30 can be acquired first to establish the Bluetooth paired connection for unlocking the electronic door lock device 20. When the portable electronic device 10 is near to the electronic door lock device 20 for accessing the electronic door lock device 20 next time, the fee is charged afterwards because the authorization code is not matched.

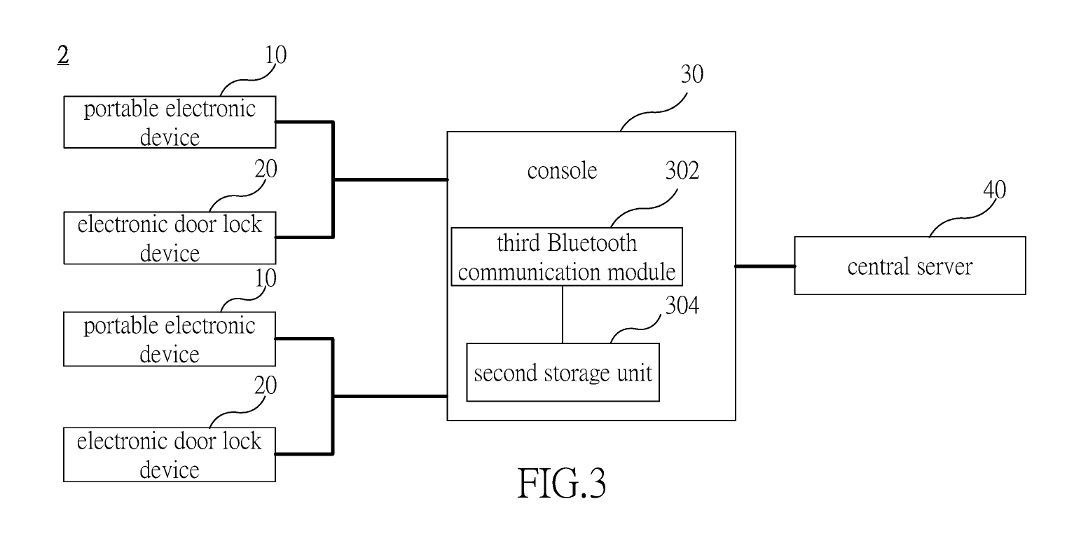

Please refer to FIG. 3, which is a functional block diagram according to the other embodiment of the present invention. In aforementioned embodiment of the present invention, the Bluetooth paired connection is established between the portable electronic device 10 and the electronic door lock device 20 by utilizing the on-site verification, i.e. the portable electronic device 10 is Bluetooth paired to the electronic door lock device 20 or Bluetooth paired to the console 30 electrically connected with the electronic door lock device 20 directly. Furthermore, a central server 40 is comprised in one embodiment of the present invention, as shown in FIG. 3.

A network connection is established between the central server 40 and the console 30, wherein the console 30 is electrically connected with a plurality of the electronic door lock devices 20 for central controlling them. In one embodiment of the present invention, users can pre-build up the authorization code exchanged between the portable electronic device 10 and at least one console 30 or at least one electronic door lock device 20 via the central server 40. The authorization code is delivered from the central server 40 for setting the door lock settings of the foregoing authorization code at the same time. When users acquire the authorization code, the door lock settings are accomplished simultaneously.

To sum up, an electronic door lock system is provided by the present invention. It comprises a portable electronic device, and an electronic door lock device. A Bluetooth paired connection is established and an authorization code is exchanged between a first Bluetooth communication module of the portable electronic device and a second Bluetooth communication module of the electronic door lock device. When the portable electronic device is near to the electronic door lock device, the authorization code is matched between the portable electronic device and the electronic door lock device. After the match is confirmed, the access control of the electronic door lock device will be unlocked. Another electronic door lock system is provided by the present invention. It comprises a portable electronic device, an electronic door lock device and a console, wherein the console is electrically connected with the electronic door lock device. A Bluetooth paired connection is established and an authorization code is exchanged between a first Bluetooth communication module of the portable electronic device and a third Bluetooth communication module of the console. When the portable electronic device is near to the electronic door lock device, the authorization code is matched between the portable electronic device and the console. After the match is confirmed, a control signal is delivered from the console to the electronic door lock device, and the access control of the electronic door lock device will be unlocked.

Compared to the prior art, the past one-to-one electronic door lock devices are promoted to many-to-one electronic door lock devices by utilizing the present invention, which can be applied for the public lockers or the access control systems to offer users more convenient using experience.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the meets and bounds of the appended claims.

What is claimed is:

1. An electronic door lock system comprising:
a portable electronic device, comprising a first Bluetooth communication module; and
an electronic door lock device, comprising a second Bluetooth communication module;
when the portable electronic device is Bluetooth paired to the electronic door lock device, an authorization code is exchanged between the first Bluetooth communication module and the second Bluetooth communication module, wherein when the portable electronic device is near to the electronic door lock device, the authorization code is matched between the portable electronic device and the electronic door lock device, and after the match is confirmed, the electronic door lock device will be unlocked.

2. The electronic door lock system of claim 1, wherein the authorization code is transmitted to the electronic door lock device via the portable electronic device.

3. The electronic door lock system of claim 1, wherein the authorization code is transmitted to the portable electronic device via the electronic door lock device.

4. The electronic door lock system of claim 1, wherein a broadcast message is delivered from the first Bluetooth communication module and the broadcast message is received by the second Bluetooth communication module to establish the Bluetooth paired connection.

5. The electronic door lock system of claim 1, wherein the authorization code is a media access control address of the first Bluetooth communication module, a media access control address of the second Bluetooth communication module or a crypto code.

6. An electronic door lock system comprising:
a portable electronic device, comprising a first Bluetooth communication module;
a console, comprising a third Bluetooth communication module, wherein when the portable electronic device is Bluetooth paired to the console, an authorization code is exchanged between the first Bluetooth communication module and the third Bluetooth communication module; and
an electronic door lock device, which is electrically connected with the console, wherein when the portable electronic device is near to the console, the authorization code is matched between the portable electronic device and the console, and after the match is confirmed, a control signal is delivered from the console to the electronic door lock device so as to unlock the electronic door lock device.

7. The electronic door lock system of claim 6, wherein the authorization code is transmitted to the console via the portable electronic device.

8. The electronic door lock system of claim 6, wherein a broadcast message is delivered from the first Bluetooth communication module and the broadcast message is received by the third Bluetooth communication module to establish the Bluetooth paired connection.

9. The electronic door lock system of claim 6, wherein the authorization code is a media access control address of the first Bluetooth communication module, a media access control address of the third Bluetooth communication module or a crypto code.

10. The electronic door lock system of claim 6, wherein the electronic door lock system further comprises a first network communication module and the console further comprises a second network communication module, and the first network communication module and the second network communication module are communicated by utilizing an Ethernet local area network module, a Wi-Fi wireless local area network module or other cable network modules or other wireless network modules for communication.
